(19) United States
(12) Patent Application Publication
(10) Pub. No.: US 2016/0352832 A1
(43) Pub. Date: Dec. 1, 2016

(54) ENHANCING DATA CONSISTENCY IN CLOUD STORAGE SYSTEM BY ENTRANCE DATA BUFFERING

(71) Applicant: Alibaba Group Holding Limited, Georgetown (KY)

(72) Inventor: Shu LI, Santa Clara, CA (US)

(21) Appl. No.: 14/727,478

(22) Filed: Jun. 1, 2015

(51) Int. Cl. H04L 29/08; H04L 1/08

(52) U.S. Cl. CPC H04L 67/1097; H04L 1/08

(57) ABSTRACT

System and method of storing data into a cloud system with high data consistency. The cloud system utilizes a non-volatile buffer at an entrance stage server to buffer incoming data as received. The data traverses from the entrance stage through various transaction stages in a data path until it is written to a destination storage device of the cloud system. Data is transmitted across stages in a pipelined manner according to an event-based schedule. A respective stage is capable of receiving a data unit from the last stage, caching and/or processing the data unit, verifying data consistency, and sending to the next stage. If a data error is detected in the data path, the identified data unit is recovered from non-volatile buffer, inserted in the data stream and resent over the data path.

### TECHNICAL FIELD

The present invention is related to the field of cloud storage systems, and in particular, related to mechanisms of ensuring data consistency in cloud storage systems.

### BACKGROUND

Cloud storage serves as virtualized pools for users to store digital data over the Internet. A cloud storage system includes multiple physical storage servers (often in multiple locations) and is typically owned and managed by a hosting company. These cloud storage providers are responsible for keeping the data available and accessible, and the physical environment protected and running Individual and organizational users buy or lease storage capacity from the providers to store data or applications.

Usually user data needs to traverse a long data path before it is eventually written to the chunk servers in a cloud storage system. The data path typically includes a few layers, each layer possibly having multiple stages where the data is buffered, cached and/or processed, such as for compression and encryption. It is well recognized that data consistency is crucial to cloud storage services. However, during the courses of data transmission, caching and processing, various problems in hardware, software, and communication may cause data inconsistency so that the data cannot be faithfully and securely written to the storage disk of a chuck server. For example, user data may be altered in unintended manners due to bugs in software or cache, system bad behaviors, system power failure, memory bits flips, communication interferences, or etc.

In one conventional approach, software based on various consistency models is used to control data consistency. Unfortunately, such software tends to yield false consistency results and is usually unreliable and itself prone to cause data error. Also, this approach is ineffective to data errors caused by unexpected power loss or reset in a data center, disk driver or firmware bugs, problems in disk controllers, and alike.

Another conventional approach relies on metadata to recover inconsistent data. However, in the situations that the file system or pointed path in the metadata fails, the metadata itself becomes invalid and useless for data recovery.

### SUMMARY OF THE INVENTION

Therefore, it would be advantageous to provide a reliable and efficient mechanism to maintain data consistency during data transmission in cloud storage systems.

Embodiments of the present disclosure employ a non-volatile buffer at an entrance stage (e.g., a front end server) of a cloud storage system to buffer incoming data as received. The data traverses a data path from the entrance stage through various transaction stages (or stages) until it is written to a destination storage disk of the cloud storage system. A respective stage is capable of receiving a data unit from the last stage, caching and/or processing the data unit, verifying data consistency, and sending to the next stage. Data is transmitted across stages in a pipelined manner according to an event-based schedule. If an error concerning data consistency of a data unit is detected in the data path, a request is sent to the entrance stage for recovering the data unit. In response, the data unit as received is retrieved from the buffer at the entrance stage, inserted in the data stream and resent over the data path.

The buffer at the entrance stage may be implemented as a barrel shifter or a log-structured buffer using reliable non-volatile memory modules. The depth of the buffer may be chosen so as to match the number of stages in the data path.

Because the original incoming data is stored in a buffer of high reliability at the cloud system entrance, the original data can be retrieved and resent when data inconsistency is detected in the data path. Thereby, the present disclosure advantageously ensures that data written and stored in the cloud storage is consistent with the received data. Moreover, data consistency in a cloud system is advantageously enhanced without introducing complex and expensive hardware modifications in the cloud system.

According to one embodiment, a computer implemented method of storing data in a cloud storage system includes receiving a stream of data units at an entrance edge node of the cloud storage system, where the cloud system includes a data path having the entrance node, intermediate nodes, and a destination storage node. The data units are buffered at the entrance node and successively sent to the intermediate nodes for caching in a pipelined manner, until they are stored in the destination storage node. Upon receiving an indication that an error is detected in the data path with respect to an identified data unit, the identified data unit is resent from the entrance node over the data path.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1A illustrates an exemplary cloud system capable of buffering incoming data at the entrance edge before the data is written to a storage server in accordance to an embodiment of the present disclosure;

FIG. 1B illustrates an exemplary data path in a cloud storage system according to an embodiment of the present disclosure;

FIG. 2 is a flow chart depicting an exemplary computer implemented process\of delivering incoming data for storage within a cloud system in accordance with an embodiment of the present disclosure;

FIG. 3 is a chart illustrating the time variation of stage statuses during data delivery in an exemplary cloud system in accordance with an embodiment of the present disclosure;

FIG. 4A is a chart illustrating the time variation of stage statuses where an inconsistent data unit is resent from the buffer at the entrance node in accordance with an embodiment of the present disclosure;

FIG. 4B is a chart illustrating the time variation of stage statuses where an inconsistent data unit is resent from the entrance node and inserted into the data stream in accordance with an embodiment of the present disclosure;

FIG. 5A is a chart illustrating the time variation of stage statuses where a group of data units error out and are resent from the entrance node in accordance with an embodiment of the present disclosure;

FIG. 5B is a chart illustrating the time variation of stage statuses where a group of data units error out and are resent from the entrance node and inserted into the data stream in accordance with an embodiment of the present disclosure;

FIG. 6A is a chart illustrating the time variation of data statuses in an exemplary barrel shifter buffer at the entrance stage of a cloud system in accordance with an embodiment of the present disclosure;

FIG. 6B illustrates the sequence of pushing received data into an exemplary barrel shifter at the entrance stage of a cloud system in accordance with an embodiment of the present disclosure;

FIG. 6C illustrates of the sequence of pushing received data into an exemplary log-structured buffer at the entrance stage in accordance with an embodiment of the present disclosure; and

FIG. 7 illustrates an exemplary computing system configured to manage data transmission in a cloud storage system accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### Enhancing Data Consistency in Cloud Storage System by Entrance Data Buffering

Overall, embodiments of the present disclosure provide a cloud storage system utilizing a non-volatile buffer to store a copy of the original incoming data at the entrance of a data path. The incoming data traverses across multiple intermediate stages in the data path in a pipelined manner before being eventually written to a destination storage device. If data inconsistency is detected with respect to a particular data unit during the course of delivery, the data unit is retrieved from the buffer and sent across the data path again.

Herein, the terms of “stage” and “node” are used interchangeably unless specified otherwise.

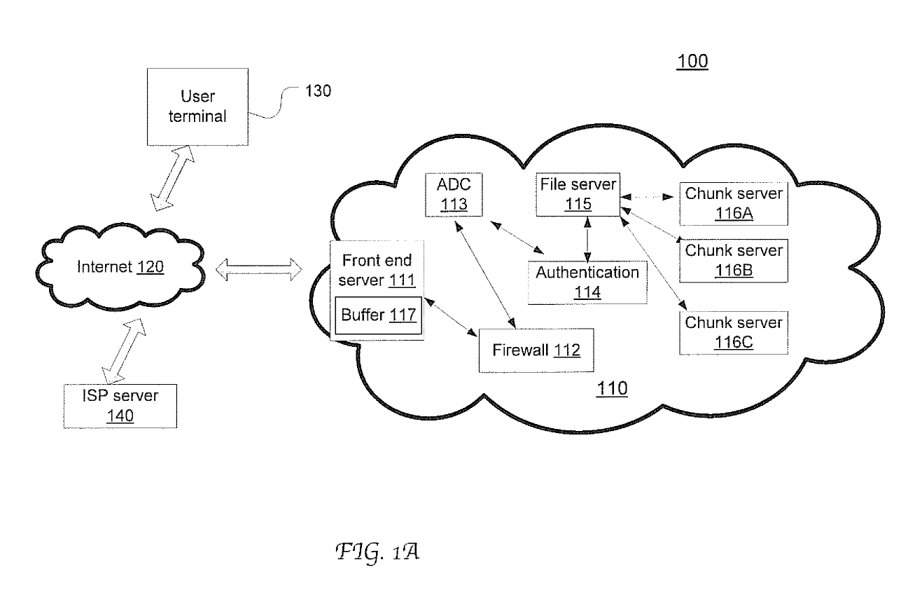

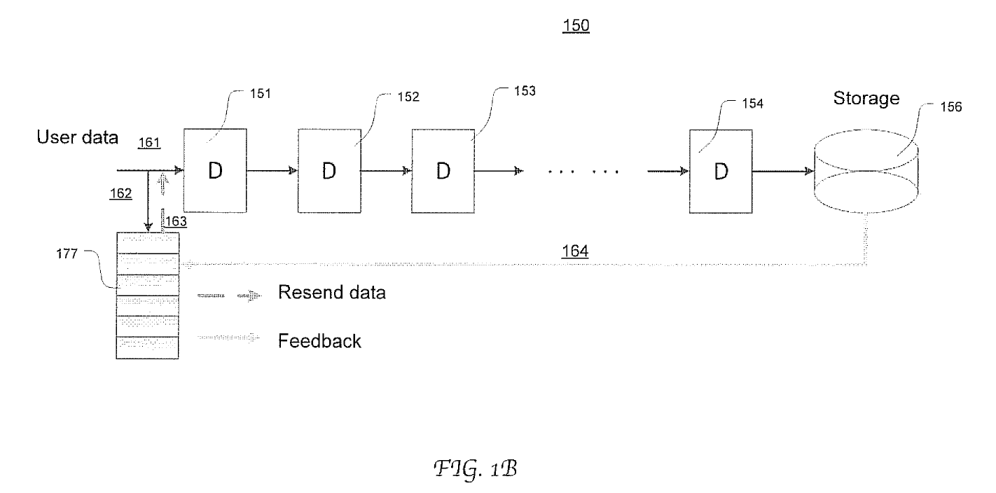

FIG. 1A illustrates an exemplary network 100 and cloud system 110 capable of buffering incoming data 101 at the entrance of the cloud system 110 before the data is written to a storage server according to an embodiment of the present disclosure. The user data 101 originates from the user terminal device 130 and is transmitted to the cloud system 110 for storage through the Internet 120. The Internet service provider 140 controls the user's access to the Internet 120.

The cloud system 110 includes a front end server 111 (or an ingress edge node) to at the entrance of the system, multiple intermediate servers 112-115 and the chunk servers 116A-116C. The incoming data needs to traverse the intermediate servers 112-115 before being written to the non-transitory storage medium in a chuck server. In this example, the intermediate servers include a firewall server 112, an application delivery controller (ADC) 113, an authentication server 114, a file server 115, and etc. However, it will be appreciated that the present disclosure is not limited by the functions, composition, infrastructure or architecture of a cloud system. Nor is it limited by the type of data that is transmitted to and stored in a cloud system. The servers 112-115 communicate with each other through a network which may be a private network, public network, Wi-Fi network, WAN, LAN, an intranet, the Internet, a cellular network, or a combination thereof.

According to the present disclosure, an edge node (here the front end server 111) of the cloud system 110 includes a buffer 117 capable of storing a copy of the original incoming data 101 upon it is arrives at the edge of the cloud system. The original data is maintained in the buffer 117 until it is confirmed that data has been accurately written to a chunk server (e.g., 116A-116C). If data inconsistency of a particular data unit is detected, the front end server 111 is instructed to recover the original copy of the data unit from the buffer 117 and resend it over the data path. Each of the servers 111-116C in the data path is configured to receive a data unit from a last stage server, cache and/or process or the data unit and then pass it to the next stage server. As each data unit is verified when it passes an intermediate stage server, any potential data error can be captured and recovered before it is written to the chunk server. As a result, the incoming data 101 can be faithfully stored in the cloud storage system 110.

FIG. 1B illustrates an exemplary data path 150 in a cloud storage system according to an embodiment of the present disclosure. The data path 150 includes an entrance stage (not explicitly shown) which serves to receive incoming data at the ingress edge of the cloud system. The data path 150 further includes a series of stages 151-156 operable to cache and process the data before it is physically written to the storage device 156. For example, the stages 151-156 corresponds to the various severs 112-116C in FIG. 1A.

In this example, incoming data is transmitted in data units across the stages 151-156 in a pipelined manner. A buffer 177 at the entrance stage (not explicitly shown) stores the incoming data 161 as they are initially received by the cloud system. At a certain time during data transmission, the various stages of the pipeline (the stages 151-156) cache different data units, as described in greater detail below. When it is confirmed that the data 161 has been successfully and accurately written to the destination storage 156 (see the feedback line 164), the data may be cleared from the buffer 177.

A conventional approach to increase data consistency a cloud system involves using write-through in the cache of various stages in the system, which is more reliable than write-back. However, this inevitably and undesirably increases the data transmission delay. Another approach utilizes non-volatile memory in the various stages for caching data, which unfortunately adds substantial cost to the system. According to embodiments of the present disclosure, by maintaining the original copy of incoming data until they are successfully written to a destination device, data consistency can be enhanced without requiring costly upgrade and configuration of various stages in the data path.

Each data unit contained in the incoming data traverses the stages 151-156 along the path 150 successively. Each time a data unit passes a stage, it is verified if the data unit exiting the stage matches with the data unit entering the stage. The verification may be performed by the respective stage or a master controller of the cloud system and using various suitable techniques that are well known in the art. If data inconsistency is detected at a particular stage, the data unit is identified and a message is generated to instruct the buffer 177 to resend the identified data unit over the path.

In some embodiments, each stage is equipped to verify data consistency, e.g., by cyclic redundancy check (CRC). If it is detected that a data unit is altered in an unintended manner, the stage reports an error which is communicated to the entrance stage for resending the data unit.

Embodiments of the present disclosure verify data consistency as data progresses in stages along the data path, thereby ensuring that the data eventually written to the destination storage device is free of error. As the original incoming data remains available at the entrance stage for retrieval, data errors caused by any type of transactions along the data path can be advantageously captured and recovered by resending the data unit.

The present disclosure is not limited to specific causes of data inconsistency in a cloud system data path. When a data unit passes a particular stage, a data error may occur during the transactions of data receiving, caching, processing, transmitting, etc. Data errors may be caused by an unexpected power loss, hardware or software bugs, system bad behaviors, memory bits flips, communication interferences, or alike.

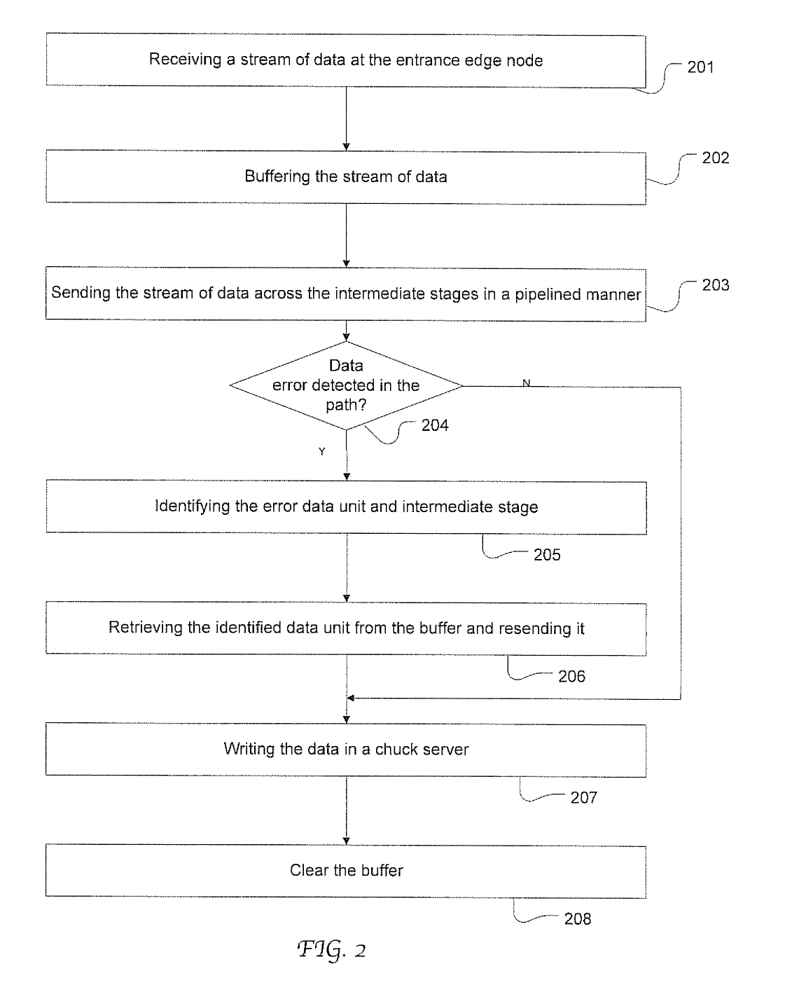

FIG. 2 is a flow chart depicting an exemplary computer implemented process 200 of delivering incoming data for storage in a cloud system in accordance with an embodiment of the present disclosure. At 201, a stream of data units is received at the entrance stage of the cloud system. The entrance stage includes a buffer used to buffer the data as received at 202. At 203, the data units are sent from the entrance stage through the various intermediate stages in a pipelined manner.

Before each stage passes a data unit to the next stage, data consistency is verified with respect to the data unit at 204. If no error occurs, the data unit can be passed to the next stage. If a data error is detected, the data unit is identified at 205, e.g., based on the identification of the intermediate stage and the reporting time of the error. In response, a request for resending the data unit is generated and instructs the entrance stage to resend the identified unit from the buffer at 206. After a data unit passes all stages successfully, it is written to a chuck server for storage at 207. If it is confirmed that all the data units in the stream are verified to be consistent and accurately written to the chuck server, the copy of data maintained in the buffer may be cleared or overwritten at 208.

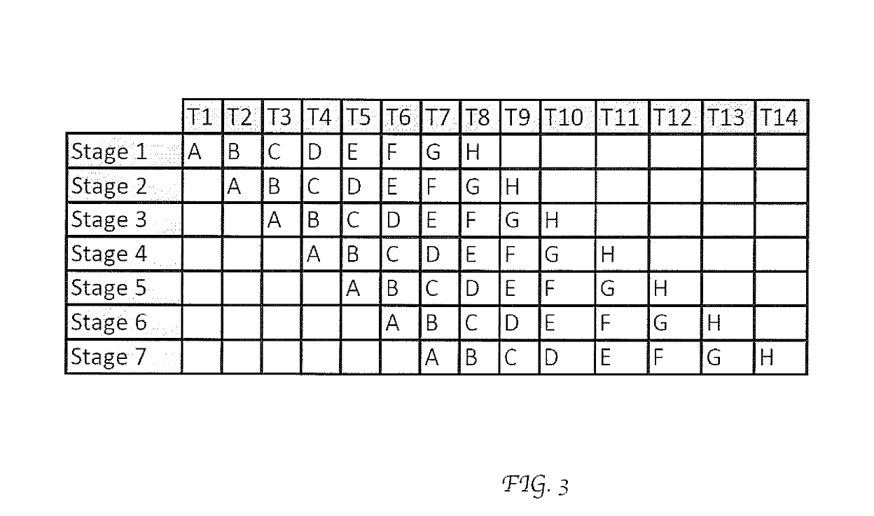

FIG. 3 is a chart illustrating the time variation of stage statuses during data delivery in a cloud system in accordance with an embodiment of the present disclosure. In this example, from time T1 to T14, the data units A-H successively pass seven consecutive stages of the cloud system in a pipelined manner and no data error has been detected. For example, at time T1, data unit A is cached in the first stage (Stage 1) while other stages contain no data; at time T2, data unit A is cached in Stage 2 while data unit B is cached in Stage 1, and so on.

It will be appreciated that the intervals between the times T1 to T14 are not necessarily equal due to different data processing time in respective stages and different transmission latency between the stages. In some embodiments, the data transmission across stages may be triggered by predefined events. For example, a data unit (e.g., data D) is transmitted from one stage (e.g., Stage 1) to the next (Stage 2) in response to a confirmation that the next stage (Stage 2) has successfully passed the preceding data unit (data C) to the second next stage (Stage 3). This can prevent data C in Stage 2 from being overwritten by data D before data C is successfully received by Stage 3. Various other events can be also defined to trigger data transmission between stages for various purposes. In some embodiments, a handshaking protocol is used such that the stages can communicate with each other with respect to their data statuses. For example, a stage can send a notification to its last stage indicating that it is ready to receive the next data unit.

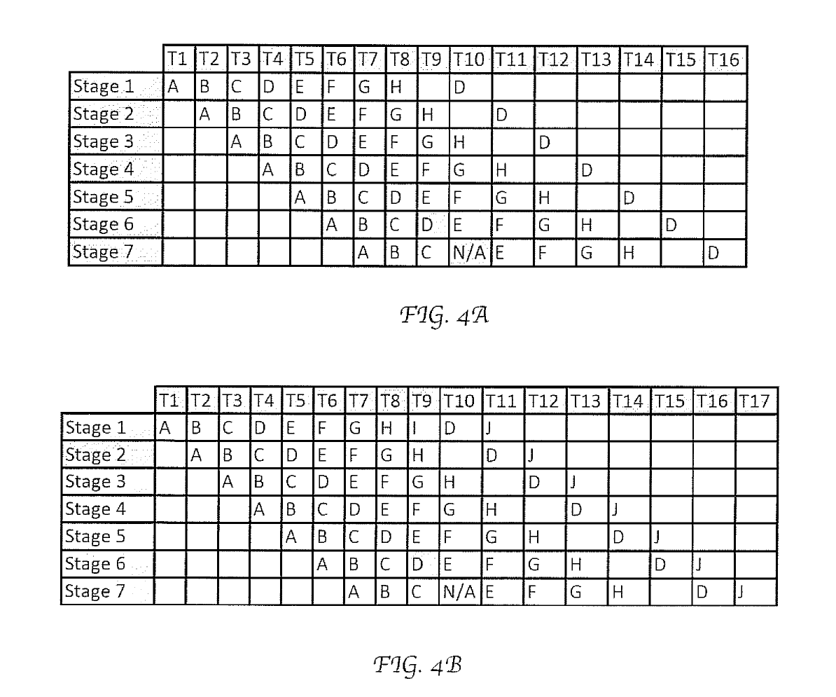

If any stage detects data inconsistency with respect to a data unit currently stored therein, the stage sends a recovery request to the entrance node, e.g., directly or through a central controller of the cloud system. In response, the data unit as received at the entrance stage is retrieved from the buffer and resent over the path via Stages 1-7. FIG. 4A is a chart illustrating the time variation of stage statuses where an inconsistent data unit is resent from the buffer at the entrance stage in accordance with an embodiment of the present disclosure. Different from the example presented in FIG. 3, at time T9, data D at Stage 6 is determined to become inconsistent with the originally received version and thus is not passed to Stage 7 at T10 (Stage 7 status is “N/A” at T10). Rather, at T10, data D is retrieved from the buffer at the entrance stage and reenters the data path from Stage 1. As shown, the reentry of data D in the data path does not affect the transmission of subsequent data units E-H in the path. In this example, when an error is detected (inconsistent data D), no new data enters the data path following the last data unit H.

In some embodiments, when resending a data, the entrance stage may suspend accepting new incoming data. This advantageously prevents data traffic congestion at the entrance and overflow of the buffer, and ensures that the data units are drained from the buffer in the order that they are received.

FIG. 4B is a chart illustrating the time variation of stage statuses where an inconsistent data unit is resent from the entrance stage and inserted in the data stream in accordance with an embodiment of the present disclosure. Different from the example in FIG. 4A, at the time (T9) that data D is detected to be inconsistent, Stage 1 is occupied by data I and thus unavailable for receiving data D that has been resent. Data D is thus inserted between data I and J at T10 and enters Stage 1, which postpones the transmission of data J and the following data units (not shown).

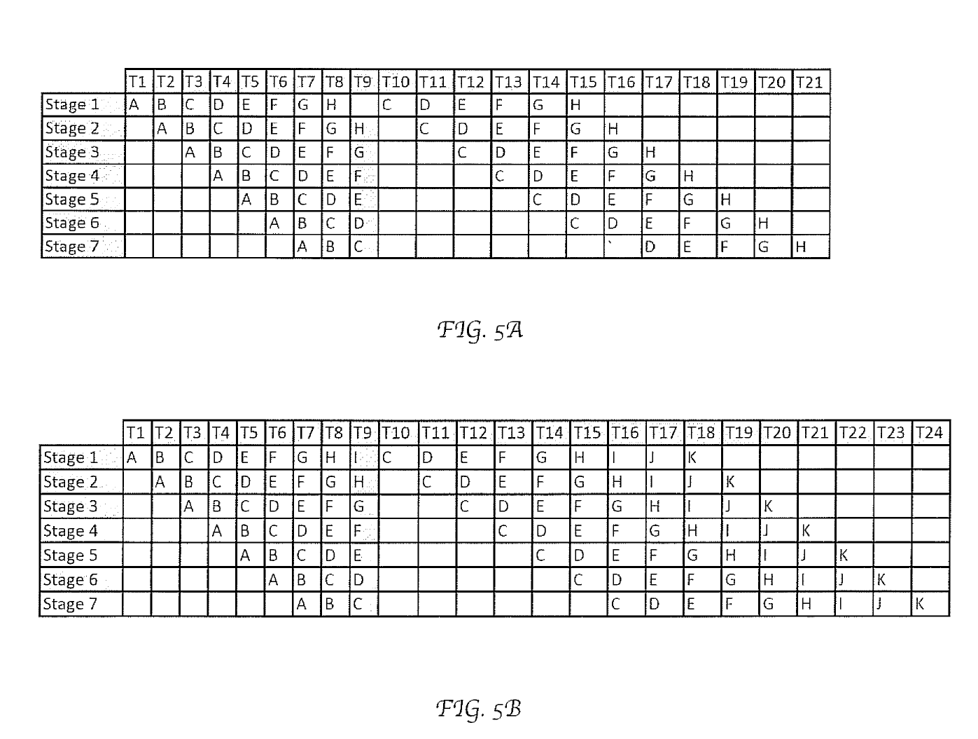

FIG. 5A is a chart illustrating the time variation of stage statuses where a group of data units error out and are resent from the entrance stage in accordance with an embodiment of the present disclosure. In this example, all the stages lost data (data C-H) at time T9, e.g., due to system power failure. Assuming the power is back at T10, the data C-H are then resent from the buffer in the entrance stage and reenter the data path in the sequence that they are received by the cloud system. Any new data (not shown) is postponed until H reenters the data path at T15.

FIG. 5B is a chart illustrating the time variation of stage statuses where a group of data units error out and are resent from the entrance node and inserted in the data stream in accordance with an embodiment of the present disclosure. FIG. 5B shows that at T9, data C-I are lost and are recovered sequentially from the buffer from the entrance stage starting T10. Had it not been any data error, data J should have be scheduled to enter the path at T10. Due to the data error, data C-I are inserted before data J and K, which delays the transmission of J and K. As shown, if Stage 7 is the destination storage device, the data A-K are written to Stage 7 in the same order as they are received by the cloud system.

The present disclosure is not limited by memory type, capacity, circuitry design or any other configuration aspect of the buffer at an entrance stage. In some embodiments, the buffer is implemented as a barrel shifter and operates to buffer incoming data in a First-In-First-Out manner (FIFO). The depth of the buffer preferably matches the number of stages included in the data path to prevent buffer overflow. In some embodiments, if the buffer is unavailable to accept new data (e.g., for an extended time) because the buffered data have not been successfully written to destination storage devices, the entrance stage may temporarily stop taking in new data. A message may be sent to the user device informing of the delay.

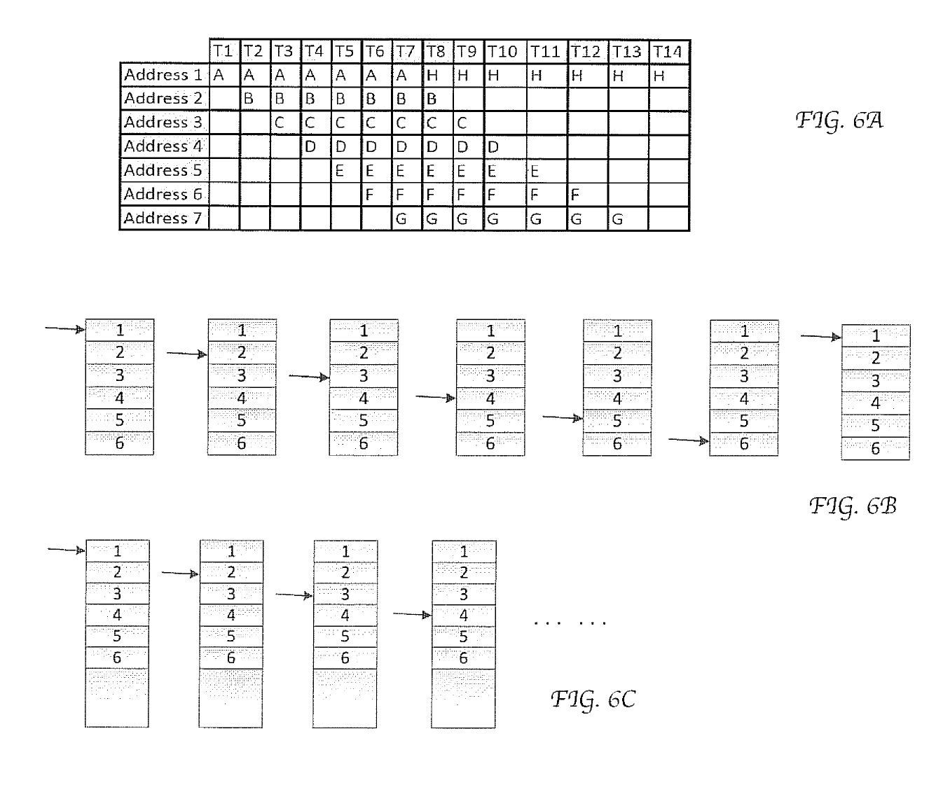

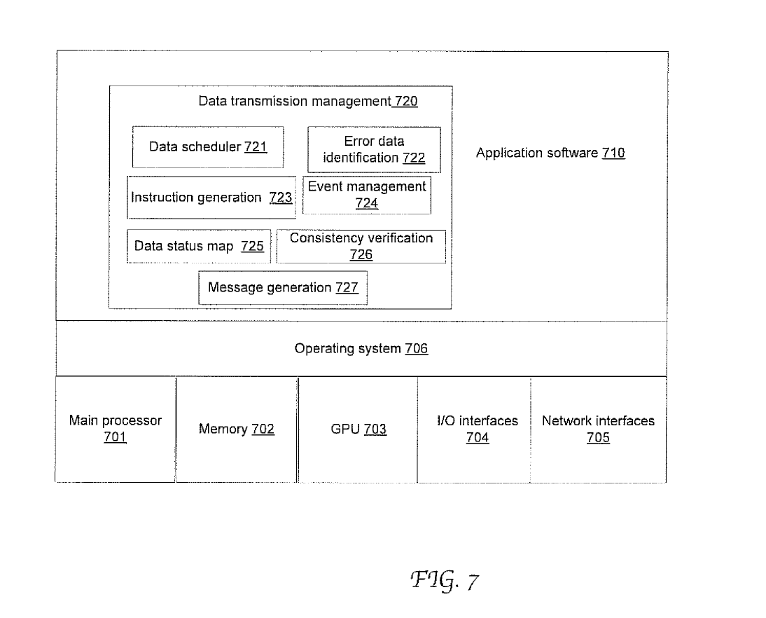

FIG. 6A is a chart illustrating the time variation of data statuses in an exemplary barrel shifter buffer at the entrance stage of a cloud system in accordance with an embodiment of the present disclosure. The data path described with reference to FIG. 6A has the same configuration as the one used in FIG. 3. In this simplified example, the data path has seven stages and accordingly the buffer has seven data addresses. Data units A-G are pushed to Addresses 1-7 respectively in sequence. Any data that has been successfully written to the final storage device can be cleared form the buffer to make room for new incoming data.

Referring back to FIG. 3. At T7, data A is successfully written to the destination Stage 7 (e.g., the storage disk in a chuck server). From this point, data A no long needs to be stored in the entrance stage buffer. Referring to FIG. 6A. At time T8, new data H overwrites data A and remains in Address 1 through time T14 because there is no additional data following data H. The data units B-G are cleared from the buffer at T9-T14 respectively.

FIG. 6B illustrates the sequence of pushing incoming data into an exemplary barrel shifter at the entrance stage of a cloud system in accordance with an embodiment of the present disclosure. Incoming data units are pushed to the buffer in incremental addresses. Because the depth of the buffer matches the number of stages in the data path, the buffer can be cleared after the data in the last address is consumed.

In some other embodiments, the entrance stage buffer is implemented as a log-structured buffer, for example using flash memory. FIG. 6C illustrates the sequence of pushing incoming data into an exemplary log-structured buffer at the entrance stage in accordance with an embodiment of the present disclosure. A plane in a solid stage drive (SSD) can be configured as a circular-log buffer, where data is pushed to incremental addresses and each read address corresponds to the position of the current pointer plus an offset. In this manner, the data stored in the buffer needs not to be cleared as soon as they are written to the destination storage device, which advantageously contributes to prolong the lifetime of the SSD. When new data comes in, it can be stored in the subsequent and unoccupied slots of the buffer until the plane is fully occupied. Advantageously, the large capacity of an SSD buffer can significantly reduce the frequency of data erasure and avoid interruption of data flow to the cloud system yet with excellent cost-efficiency.

In one embodiment, the log-structured SSD buffer is configured to maintain write amplification (WA=1) and block the operations of garbage collection, wear leveling and over-provisioning. Thus, incoming data is written to the buffer in the same order as it is received. As a result, if a particular stage frequently causes data inconsistency and data recovery from the buffer, read access to the buffer can be limited to a relatively small address range.

In some other embodiments, a buffer at the entrance stage of a cloud system can be implemented using hybrid dual-in line memory modules (DIMM) which combine dynamic random access memory (DRAM), flash memory and super capacitors. The DRAM has a large capacity with an allocated space for use as the buffer. The size of the buffer can be defined based on the number of stages included in the data path and the sizes of individual data units. Flash memory typically has problems related to block erasure and memory wear and so may be reserved for storing data at times of power failure. For example, when power is lost, the super capacitor supplies the power for transferring data from the DRAM buffer to the single level cell (SLC) flash memory. When the power is back, the transferred data is accessed from the flash memory for transmission (or re-transmission) over the data path.

The hybrid DIMM may integrate different types of memory chips into a multi-chip-package, such as a combination of NOR flash memory and static random access memory (SRAM), a combination of NOR and NAND flash memory and SRAM, a combination of NAND and DRAM, or any other suitable combinations. In still some other embodiments, the entrance stage buffer includes non-volatile DIMMs (NVDIMMs), e.g., using phase change memory (PCM) as the storage medium.

In a cloud system according to the present disclosure, data transmission/recovery scheduling, and communication among various stages in a data path (as described with reference to FIG. 1A-7) can be managed in a centralized manner. For example, a master control server collects and maintains the information related to the states of various stages and the entrance stage buffer. Based on the information, the master control server identifies the inconsistent data unit and the reporting stage, determines appropriate data transmission and recovery schedules, modifies the data transmission sequences, and generates instructions for the stages to act accordingly.

In some other embodiments, the data transmission/recovery scheduling is controlled in a distributed manner where the stages communicate with each other and operate in accordance to a handshaking protocol. For example, a stage may report an inconsistent data unit directly to the entrance stage, which prompts the entrance stage to identify a proper time slot and resend the data unit over the data path. Each stage communicates with its adjacent neighbor stages regarding data receiving and transmission events. Any other suitable control architecture can also be used without departing the scope of the present disclosure, e.g., a combination of centralized and distributed control or a hierarchical control architecture. Further, various processes of verifying data consistency may be performed in respective stages or in a central controller.

FIG. 7 illustrates an exemplary computing system 800 configured to manage data transmission in a cloud storage system in accordance with an embodiment of the present disclosure. The computing system 700 may correspond to a master control server of the cloud system. The computing system 700 includes a processor 701, system memory 702, a graphics processing unit (GPU) 703, I/O interfaces 704 and network circuits 705, an operating system 706 and application software 710 stored in the memory 702. The software 710 includes the data transmission management program 720 having modules for data scheduling 721, error data identification 722, instruction generation 723, event management 724, data status map 725, consistency verification 726, message generation 727, and etc.

When executed by the CPU 701, the data transmission management program 720 controls transmission of respective data units in a data path within the cloud system to ensure data consistency. The event management module 724 receives information from each stage regarding the events of data receiving, sending, verification, error detection, and etc. Based on the corresponding events, the data scheduler 721 determines appropriate times for transmitting respective data units across various stages in the data path, as described in greater detail with reference to FIG. 2A. If data recovery is needed, the scheduler 721 identifies a time slot for resending the recovered data unit and accordingly postpones the subsequent data units, as described in greater detail with reference to FIG. 3A-4B.

The data status map module 725 keeps track of the identification of the data unit in each stage at each time (see FIG. 2A). Responsive to a data error indication reported by a particular stage, the error data identification module 722 identifies the data unit and the reporting stage by looking up the data status map. Accordingly, the instruction generation module 723 sends an instruction to the entrance stage for retrieving and resending the identified data unit. The verification module 726 verifies data consistency after data is cached and/or processed in various stage servers. If data transmission is delayed in the data path for an extended time, the message generation module 727 generates a message notifying the data sender to stop sending new data.

The data transmission management program 720 is configured to perform other functions as described in greater detail with reference to FIGS. 1-7, and may include various other components and functions that are well known in the art. As will be appreciated by those with ordinary skill in the art, the program 720 can be implemented in any one or more suitable programming languages that are known to those skilled in the art, such as C, C++, Java, Python, Perl, TCL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of storing data in a cloud storage system, said method comprising:
receiving a stream of data units at an entrance node of said cloud storage system, wherein said cloud storage system comprises a data path, said data path comprising said entrance node, intermediate nodes, and a destination storage node;
buffering said stream of data units at said entrance node;
successively sending said stream of data units to said intermediate nodes for caching in a pipelined manner before said stream of data units are stored in said destination storage node; and
upon receiving an indication that an error is detected in said data path with respect to an identified data unit, resending said identified data unit from said entrance node over said data path.

2. The computer implemented method of claim 1, wherein said resending comprises:
postponing sending a next data unit that has been scheduled to be sent to said data path at a first time; and
sending said identified data unit from said entrance node at said first time.

3. The computer implemented method of claim 1, wherein a respective data unit is cached in a first intermediate node until an event that a preceding data unit is successfully received by a second intermediate node that is adjacent to said first intermediate in said data path.

4. The computer implemented method of claim 1, wherein said error occurs during receiving said identified data unit at an identified intermediate node in said data path, processing said identified data unit at said identified intermediate node, or sending said identified data unit from said identified intermediate node.

5. The computer implemented method of claim 1 further comprising overwriting said stream of data units in said entrance node upon said stream of data units being successfully stored in said destination storage node.

6. The computer implemented method of claim 1 further comprising overwriting said stream of data units from said entrance node upon a plurality of subsequent streams of data units being successfully stored in said destination storage node.

7. The computer implemented method of claim 1 further comprises: if receiving additional data units causes buffer overflow at said entrance node, sending a message to a user indicating that data transmission in said cloud storage system is delayed.

8. The computer implemented method of claim 1, wherein said buffering comprises buffering said stream of data in non-volatile memory in a first-in-first-out manner until said error is detected.

9. An apparatus in a cloud system, said apparatus comprising:
a processor;
communication circuits coupled to said processor, wherein said communication circuits are further coupled to said cloud system via a network; and
memory coupled to said processor and comprising instructions executable by said processor, wherein said instructions implement a method comprising:
causing a buffer of said cloud system to store incoming data received by said cloud system;
receiving an error indication from a data path of said cloud system indicative of data consistency during transmission of said incoming data to a destination storage server via said data path; and
responsive to said error indication, causing said buffer to resend said incoming data to said destination storage server.

10. The apparatus of claim 9, wherein: said buffer is disposed at an entrance node of said cloud system; said entrance node is configured to receive said incoming data transmitted from Internet; and said transmission of said incoming data comprises transmission between said entrance node and said destination storage server through intermediate nodes of said data path in a pipelined manner.

11. The apparatus of claim 10, wherein: said buffer comprises a barrel shifter; a depth of said buffers is related to a number of said intermediate nodes in said data path; said method further comprises: receiving a confirmation that said incoming data has been successfully stored in said destination storage server; and causing said incoming data to be removed from said buffer.

12. The apparatus of claim 10, wherein a respective intermediate node of said intermediate nodes is configured to:
receive a first data unit of said incoming data from an upstream intermediate node in said data path and generate an indication of a safe receipt event;
process said first data unit;
verify data consistency of said first data unit; and
if data consistency is verified, send said first data unit to a downstream intermediate node in said data path and generate an indication of a safe passing event;
if data inconsistency is detected, generate an indication of an error event.

13. The apparatus of claim 9, wherein said buffer comprises a hybrid dual-inline memory module.

14. The apparatus of claim 12, wherein said method further comprises:
identifying an data unit of said incoming data based on said error indication;
postponing sending a next data unit that has been scheduled to be sent over said data path at a first time; and
signaling said entrance node to resend an identified data unit over said data path from said buffer at said first time.

15. The apparatus of claim 10, wherein said method further comprises, if receiving additional data units causes buffer overflow of said buffer, sending a message to a user device coupled to said cloud system, said message indicating that data transmission in said cloud system is delayed.

16. A non-transitory computer-readable storage medium embodying instructions that, when executed by a processing device, cause the processing device to perform a method of storing data in a cloud storage system:
receiving a stream of data units at an entrance node of said cloud storage system, wherein said cloud storage system comprises a data path, said data path comprising said entrance node, intermediate nodes, and a destination storage node;
buffering said stream of data units at said entrance node;
successively sending said stream of data units to said intermediate nodes for caching in a pipelined manner before said stream of data units are stored in said destination storage node; and
upon receiving an indication that an error is detected in said data path with respect to an identified data unit, resending said identified data unit from said entrance node over said data path.

17. The non-transitory computer-readable storage medium of claim 16, wherein said resending comprises:
postponing sending a next data unit that has been scheduled to be sent to said data path at a first time; and
sending said identified data unit from said entrance node at said first time.

18. The non-transitory computer-readable storage medium Claim of 16, wherein a respective data unit is cached in a first intermediate node until an event that a preceding data unit is successfully received by a second intermediate node that is adjacent to said first intermediate in said data path.

19. The non-transitory computer-readable storage medium of claim 16, wherein said method further comprises overwriting said stream of data units from said entrance node upon a plurality of subsequent streams of data units being successfully stored in said destination storage node.

20. The non-transitory computer-readable storage medium of claim 16, wherein said buffering comprises buffering said stream of data units in non-volatile memory, and wherein said method further comprises, if receiving additional data units causes buffer overflow at said entrance node, sending a message to a user device indicating that data transmission in said cloud storage system is delayed.
